(19) United States
(12) Patent Application Publication
(10) Pub. No.: US 2011/0318630 A1
(43) Pub. Date: Dec. 29, 2011

(54) SEPARATOR FOR LITHIUM ION SECONDARY BATTERY AND LITHIUM ION SECONDARY BATTERY

(75) Inventors: Yasuhiro Wakizaka, Yokohama-shi (JP); Mayumi Fukumine, Kawasaki-shi (JP)

(73) Assignee: ZEON CORPORATION, Tokyo (JP)

(21) Appl. No.: 13/142,158

(22) PCT Filed: Dec. 25, 2009
(86) PCT No.: PCT/JP2009/071546

§ 371 Date: Sep. 14, 2011

(30) Foreign Application Priority Data
Dec. 26, 2008 (JP) 2008-334625

(51) Int. Cl. H01M 2/16; B05D 3/00; B05D 5/00

(52) U.S. Cl. 429/144; 427/58

(57) ABSTRACT

The invention intends to provide a separator for lithium ion secondary battery wherein the separator with porous film used for lithium ion secondary battery include binder, which is capable to contribute for improving film smoothness property of the separator and long term cycle property.

The invention provides a separator for lithium ion secondary battery characterized in that; porous film including nonconductive particles and binder is laminated on organic separator, and said binder includes copolymer comprising monomer unit derived from (meth)acrylonitrile monomer unit and monomer unit derived from (meth)acrylic ester, and a lithium ion secondary battery comprising; a positive electrode, a negative electrode, an electrolyte solution, and said separator.

### TECHNICAL FIELD

The present invention relates to a separator for a lithium ion secondary battery having porous film, more precisely, to a separator for a lithium ion secondary battery having porous film which possibly contributes to improve smoothness and oxidation resistivity of the separator. Also, the present invention relates to a lithium ion secondary battery provided with said separator having porous film.

### BACKGROUND ART

In a practically applied battery, a lithium ion secondary battery has a highest energy density and has been widely used for, in particular, small sized electronic devices. Also, in addition to a small sized usage, it has been prospected for expanding usage for vehicles. In this matter, it has been desired for high capacity, long term durability and more improvement of safety of the lithium ion secondary battery.

A lithium ion secondary battery normally comprises an organic separator composed of polyolefin series, such as polyethylene, polypropylene and the like, in order to prevent short circuit between positive and negative electrodes. An organic separator composed of polyolefin series has a physical property which melts at 200° C. or less. Thus, when the battery tends to get higher by internal and/or external stimuli, volume change such as shrink or melt may occur, and as a result, there is a risk of explosion caused such as by short circuit of positive and negative electrodes or electrical energy release.

Therefore, in order to solve such problems, it is proposed to have nonconductive particles such as inorganic particles on the polyethylene series organic separator.

For example, Patent Document 1 discloses a method comprising the steps of dispersing inorganic particles of BaTiO₃ powder and polyvinylidene fluoride-chlorotrifluoroethylene copolymer (PVDF-CTFE) in a dispersion medium and slurrying, then, coating the same on a polyethylene terephthalate made porous base material and drying. With this method, by including inorganic particles, thermal shrinkage of organic separator by heat of 150° C. or more can be prevented however, wrinkles and the like may occur on organic separator when coating and drying the slurry including inorganic particles.

For example, Patent Document 2 discloses a separator with porous film formed by coating porous film slurry, comprising polyvinylidene fluoride and/or polyethyleneoxide and inorganic particles such as calcium carbonate and the like, on polyethylene made organic separator. Patent Document 2 describes, when including inorganic particles, growth of lithium dendrite crystal (dendrite) at long cycle can be inhibited and electrical short circuit can be prevented. However, polyethyleneoxide used in this method is weak at high potential and its capacity will be severely deteriorated at long cycle or high-temperature operation.

Therefore, according to the Patent Documents 1 and 2, by forming porous film including nonconductive particles such as inorganic particles, electrical short circuit can be prevented and thermal shrinkage can be inhibited. However, deformation, such as wrinkles and the like may be seen when forming porous film, including inorganic particles, on polyolefin series organic separator, namely, film smoothness may be deteriorated. Further, by using the lithium ion secondary battery including said separator, long term cycle characteristic cannot be obtained.

### PRIOR ART DOCUMENTS

### Patent Documents

Patent Document 1: Japanese Laid Open Patent Publication (Tokuhyo) No. 2008-503049 (U.S. Laid-open Patent Publication No. 2006/8700)
Patent Document 2: Japanese Patent Laid Open (Tokkai) No. 2001-319634(U.S. Pat. No. 6,432,586)

### DISCLOSURE OF INVENTION

### Problem To Be Solved By the Invention

The present invention has been made in view of the above conventional technical arts; and a purpose of the invention is to provide a separator with porous film used for lithium ion secondary battery wherein said separator for lithium ion secondary battery includes binder, which is capable to contribute for film smoothness and long term cycle characteristic of the separator.

### Means For Solving the Problem

In order to solve the above-mentioned problem, as a result of intentional study by the present inventors, it has been found that deformation of porous film including nonconductive particles can be prevented when the above-mentioned porous film including nonconductive particle such as inorganic particle includes specific binder, thus, deformation of organic separator can also be prevented which leads to a superior film smoothness, and further, long term cycle characteristic can be obtained when said binder has high oxidation stability, and the present invention has been achieved thereby.

The present invention to the above problem comprises following matters as gist.

(1) A separator for lithium ion secondary battery characterized in that;
porous film including nonconductive particles and binder is laminated on organic separator,
and said binder includes copolymer comprising (meth)acrylonitrile monomer unit and (meth)acrylic ester monomer unit.

(2) The separator for lithium ion secondary battery as set forth in (1) wherein;
ratio of (meth)acrylonitrile monomer unit and (meth)acrylic ester monomer unit (=(meth)acrylonitrile monomer unit/(meth)acrylic ester monomer unit) in the copolymer of the binder is within the range of 5/95 to 50/50 by mass ratio.

(3) The separator for lithium ion secondary battery as set forth in (1) or (2) wherein;

total content of (meth)acrylonitrile monomer unit and (meth)acrylic ester monomer unit in the copolymer of the binder is 50 mass % or more.

(4) The separator for lithium ion secondary battery as set forth in any one of (1) to (3) wherein;

said binder is crosslinkable by heat or energy irradiation.

(5) The separator for lithium ion secondary battery as set forth in any one of (1) to (4) wherein;

said copolymer of the binder includes thermal crosslinkable group and said thermal crosslinkable group is at least one selected from the group consisting of epoxy group, N-methylol amide group and oxazoline group.

(6) The separator for lithium ion secondary battery as set forth in any one of (1) to (5) wherein;

said copolymer of the binder further includes at least one kind of hydrophilic group selected from the group consisting of carboxylic acid group, hydroxy group and sulfonic acid group.

(7) A manufacturing method of a separator for lithium ion secondary battery characterized by comprising;

coating a slurry for porous film comprising nonconductive particles, binder including copolymer comprising (meth)acrylonitrile monomer unit and (meth)acrylic ester monomer unit, and solvent on organic separator, and drying the same.

(8) A lithium ion secondary battery comprising;

a positive electrode, a negative electrode, an electrolyte solution, and the separator as set forth in any one of (1) to (6).

### BEST MODE FOR WORKING THE INVENTION

Hereinafter, the present invention will be explained in detail.

A separator for lithium ion secondary battery of the present invention is obtained by laminating porous film, including nonconductive particles and binder, on organic separator.

### Organic Separator

As for organic separator of the present invention, a porous film having fine pore diameter (microporous film), which does not show electron conductivity but shows ion conductivity and is highly resistant to organic solvent, is used. For instance, a microporous film formed by resin such as polyolefin series (polyethylene, polypropylene, polybutene, and polyvinyl chloride), a mixture thereof, a copolymer thereof, and the like; a microporous film formed by resin such as polyethyleneterephthalate, polycycloolefin, polyethersulfone, polyamide, polyimide, polyimideamide, polyaramid, polycycloolefin, nylon, polytetrafluoroethylene, and the like; a material woven by polyolefin series fiber or a nonwoven fabric of said fiber; and an assembly of insulating material particles can be exemplified. Above all, a microporous film formed by polyolefin series resin is preferable, in view of that it is capable of providing a superior coating property of slurry which includes nonconductive particles, and increasing capacity per volume by a thinner film thickness of separator leading to higher active material ratio in battery, which will be described later.

Thickness of the organic separator is normally 0.5 to 40 μm, preferably 1 to 30 μm, and more preferably 1 to 10 μm. Within this range, resistance of separator in battery decreases and workability of coating on separator increases.

In the present invention, as for polyolefin series resin used for a material of organic separator, homopolymer of polyethylene and polypropylene, etc., copolymer of the same and mixture thereof can be exemplified. As for polyethylene, ethylene with low, medium and high densities can be exemplified, however, considering picking strength and mechanical strength, a high density polyethylene is preferable. Further, for the purpose of providing softness, two or more kinds of said polyethylene can be mixed. As for the polymerization catalyst used for preparing said polyethylene, although there is no limitation particularly, Ziegler-Natta catalyst, Phillips catalyst and Metallocene catalyst are exemplified. In order to achieve a good balance between mechanical strength and high permeability, viscosity-average molecular weight of polyethylene is preferably a hundred thousand or more and 12 million or less, more preferably two hundred thousand or more and three million or less. As for polypropylene, homopolymer, random copolymer, block copolymer are exemplified, and it can be used by single or mixing two kinds or more. As for polymerization catalyst, although there is no limitation particularly, Ziegler-Natta catalyst and Metallocene catalyst are exemplified. As for stereoregularity, although there is no limitation particularly, isotactic, syndiotactic and atactic can be used, in particular, it is preferable to use isotactic polypropylene which is inexpensive. Further, within a capable range for preserving the effect of the invention, appropriate amount of additives such as polyolefin, other than polyethylene and polypropylene, antioxidant and astamuse can be added.

As for manufacturing method of polyolefin series organic separator, conventionally known and used methods are used. As for said methods, for example; a dry method wherein a film is formed by melt extrusion of polypropylene and polyethylene, and the resulting film is annealed at a low temperature to grow crystal domain and extended to form microporous film by extending noncrystal region; and a wet method wherein a film is formed after mixing hydrocarbon medium and the other low molecular materials with polypropylene and polyethylene, and by removing said medium and said low molecular materials with more highly volatile medium from the resulting film where said medium and said low molecular materials are aggregated and island phase begins to appear, to form microporous film, are selected. In particular, dry method is preferable in view of that big voids are easily obtained in object to decrease the resistance.

Organic separator of the present invention, in object to control strength, hardness, and thermal shrinkage, is capable of including filler or fiber compounds other than nonconducting particles. Further, when laminating porous film layer including nonconductive particles and binder, in object to improve adhesion and to improve impregnation rate of solution by decreasing surface tension of electrolyte solution, surface of the organic separator can be coated with low or high molecular compound, and electromagnetic line treatment such as by ultraviolet rays or plasma treatment such as by corona discharge or plasma gas can be done in advance. In particular, it is preferable to coat with a high molecular compound including polar groups, such as carboxylic acid group, hydroxyl group and sulfonic acid group, in view of that it has high impregnation rate of electrolyte solution and is easy to obtain high adhesion with porous film including nonconductive particles and binder.

Organic separator of the present invention, in object to strengthen the tearing strength and picking strength, can be a multilayer structure of the above organic separators. In particular, a layered structure of polyethylene microporous film and polypropylene microporous film and a layered structure of nonwoven fiber and polyolefin group separator can be exemplified.

### Nonconductive Particles

As for nonconductive particles of the present invention, it is desirable to stably present under lithium ion secondary battery environment and also be electrochemically stable. For instance, all sorts of nonconductive inorganic and organic particles can be used.

As for the inorganic particles, oxide particles such as iron oxide, silicone oxide, aluminum oxide, magnesium oxide and titanium oxide; nitride particles such as aluminum nitride and boron nitride; covalent crystal particles such as silicon and diamond; poorly-soluble ion crystal particles such as barium sulfate, calcium fluoride and barium fluoride can be used. In accordance with necessity, these particles can be treated with element substitution, treated with surface treatment, or formed to a solid solution. Further, these particles can be used alone or in a combination of two or more kinds. In particular, oxide particles are preferable, since they are stable in electrolyte solution and have potential stability.

As for the organic particles, particles comprising various polymers such as polystyrene, polyethylene, polyimide, melamine series resin, phenol series resin can be used. Said polymers forming the particles can be a mixture, a modified form, a derivatized form, random copolymer, alternate copolymer, graft copolymer, block copolymer, a bridged form. The particles may comprise two or more kinds of polymers. Further, conducting metals, such as carbon black, graphite, SnO₂, ITO and metallic powder, compounds having conducting properties, and oxides of fine powder form can also be used by surface treating them with nonconductive materials and providing them with electrical insulation property. Two or more kinds of these nonconductive materials can be used in combination.

An average particle diameter (D50 average particle diameter of volume average) of nonconductive particles of the invention is preferably within a range of 5 nm or more to 10 μm or less, more preferably lOnm or more to 5 μm or less. When the average particle diameter of the nonconductive particles is within said range, it will be easy to control dispersing state and obtain predetermined uniform thickness of the film. In particular, the average particle diameter of the nonconductive particles is preferably within a range of 50 nm or more to 2 μm or less, which will be easy to disperse and coat and is superior to control voids.

It is desirable that BET specific surface area of the particles is preferably within a range of 0.9 to 200 m²/g, more preferably 1.5 to 150 m²/g, in view of inhibiting aggregation of the particles and optimizing the fluidity of the slurry.

Formation of the nonconductive material of the invention is not particularly limited, spherical type, needle type, rod type, spindle type, plate type, scale type, etc. can be used; however, spherical type, needle type, spindle type and the like are preferable. Further, porous particles can also be used.

Content amount of nonconductive particles in the porous film is preferably within a range of 5 to 99 mass %, more preferably 50 to 98 mass %. When content amount of nonconductive particles in the porous film is within said range, separator with porous film showing high thermal stability and strength can be obtained.

### Binder

Binder of the invention includes copolymer comprising (meth)acrylonitrile monomer unit and (meth)acrylic ester monomer unit. Said copolymer is obtained by copolymerizing at least a monomer providing (meth)acrylonitrile monomer unit and a monomer providing (meth)acrylic ester monomer unit. In the invention, “(meth)acrylic acid” means acrylic acid or methacrylic acid, and “(meth)acrylo” means acrylo or methacrylo.

As for the monomer providing (meth)acrylic ester monomer unit, (meth)acrylic alkyl ester, (meth)acrylic perfluoro alkyl ester and (meth)acrylic ester, having functional group attached to aside chain, can be exemplified. Above all, (meth)acrylic alkyl ester is preferable. Carbon number of alkyl group and perfluoro alkyl group which bind to noncarbonyl oxygen atom of (meth)acrylic alkyl ester and (meth)acrylic perfluoro alkyl ester is preferably 1 to 14, more preferably 1 to 5, in view of showing lithium ion conductivity by swelling to electrolyte solution and inhibiting cross-linking aggregation of polymer when dispersing small particle diameter.

As for the (meth)acrylic alkyl ester wherein carbon number of alkyl group and perfluoro alkyl group which bind to noncarbonyl oxygen atom is 1 to 5, acrylic alkyl esters such as methyl acrylate, ethyl acrylate, n-propyl acrylate, isopropyl acrylate, n-butyl acrylate and t-butyl acrylate; acrylic 2-(perfluoro alkyl) ethyls such as acrylic 2-(perfluoro butyl) ethyl and acrylic 2-(perfluoro pentyl) ethyl; methacrylic alkyl esters such as methyl methacrylate, ethyl methacrylate, n-propyl methacrylate, isopropyl methacrylate, n-butyl methacrylate and t-butyl methacrylate; and methacrylic 2-(perfluoro alkyl) ethyls such as methacrylic 2-(perfluoro butyl) ethyl, methacrylic 2-(perfluoro pentyl) ethyl are exemplified.

As for the other (meth)acrylic alkyl esters, acrylic alkyl esters, wherein carbon number of alkyl group which bind to noncarbonyl oxygen atom is 6 to 18, such as n-hexyl acrylate, 2-ethyl hexyl acrylate, nonyl acrylate, lauryl acrylate, stearyl acrylate, cyclohexyl acrylate and isobornyl acrylate; methacrylic alkyl esters, wherein carbon number of alkyl group which bind to noncarbonyl oxygen atom is 6 to 18, such as n-hexyl methacrylate, 2-ethyl hexyl methacrylate, octyl methacrylate, isodecyl methacrylate, lauryl methacrylate, tridecyl methacrylate, stearyl methacrylate and cyclohexyl methacrylate; acrylic 2-(perfluoro alkyl) ethyls, wherein carbon number of perfluoro alkyl group which bind to noncarbonyl oxygen atom is 6 to 18, such as 2-(perfluoro hexyl) ethyl acrylate, 2-(perfluoro octyl) ethyl acrylate, 2-(perfluoro nonyl) ethyl acrylate, 2-(perfluoro decyl) ethyl acrylate, 2-(perfluoro dodecyl) ethyl acrylate, 2-(perfluoro tetradecyl) ethyl acrylate, 2-(perfluoro hexadecyl) ethyl acrylate; and methacrylic 2-(perfluoro alkyl) ethyls, wherein carbon number of perfluoro alkyl group which bind to noncarbonyl oxygen atom is 6 to 18, such as 2-(perfluoro hexyl) ethyl methacrylate, 2-(perfluoro octyl) ethyl methacrylate, 2-(perfluoro nonyl) ethyl methacrylate, 2-(perfluoro decyl) ethyl methacrylate, 2-(perfluoro dodecyl) ethyl methacrylate, 2-(perfluoro tetradecyl) ethyl methacrylate, 2-(perfluoro hexadecyl) ethyl methacrylate; can be exemplified.

As for the monomer providing monomer unit of (meth)acrylonitrile of the invention, acrylonitrile and methacrylonitrile can be exemplified.

In the invention, ratio of (meth)acrylonitrile monomer unit and (meth)acrylic ester monomer unit (=(meth)acrylonitrile monomer unit/(meth)acrylic ester monomer unit) in copolymer is preferably within the range of 5/95 to 50/50, more preferably 5/95 to 30/70, the most preferably 10/90 to 20/80 by mass ratio. When mass ratio of (meth)acrylonitrile monomer unit and (meth)acrylic ester monomer unit is within the above-mentioned range, dissolution to electrolyte solution will be prevented and deformation when coating on organic separator becomes difficult to occur. Further, while keeping swellable property to electrolyte solution, it is difficult to dissolve at a high temperature; and it shows superior high-temperature property.

In the invention, total content of (meth)acrylonitrile monomer unit and (meth)acrylic ester monomer unit in copolymer is preferably 50 mass % or more, more preferably 60 mass % or more and the most preferably 75 mass % or more. When total content of (meth)acrylonitrile monomer unit and (meth)acrylic ester monomer unit in copolymer is within the above-mentioned range, dispersibility of nonconductive particles to a solvent used for slurry, which will be described hereinafter, and softness of the porous film can both be improved.

It is preferable that the binder of the invention is crosslinkable by heat or energy irradiation. When using crosslinked binder, crosslinkable by heat or energy irradiation, crosslink density can be controlled by the strength of heat or energy irradiation. Further, when crosslink density is high, the degree of swelling becomes lower; hence the degree of swelling can be controlled by crosslink density.

Binder, crosslinkable by heat or energy irradiation, can be obtained when crosslinking agent is contained in binder and/or crosslinkable group is contained in copolymer forming the binder.

Above all, it is preferable when crosslinking agent comprising thermal crosslinkable group is contained in a binder in addition to copolymer forming the binder and/or thermal crosslinkable group is contained in copolymer forming the binder, because porous film can be crosslinked by thermal treatment after forming the porous film and dissolving to electrolyte solution can be prevented, and hence a strong and soft porous film can be obtained.

When crosslinking agent comprising crosslinkable group is contained in a binder, in addition to copolymer forming the binder, said crosslinking agent is not particularly limited, however; organic peroxide, crosslinking agents that are effective with heat or light and the like are used. Above all, organic peroxide and crosslinking agents that are effective with heat are preferable, because thermal crosslinkable group is contained.

As for the organic peroxide, ketone peroxides such as methylethylketone peroxide and cyclohexanone peroxide; peroxy ketals such as 1,1-bis(t-butylperoxy)3,3,5-trimethylcyclohexane and 2,2-bis(t-butylperoxy)butane; hydroperoxides such as t-butyl hydroperoxide and 2,5-dimethylhexane-2,5-dihydroperoxide; dialkylperoxides such as dicumyl peroxide, 2,5-dimethyl-2,5-di(t-butylperoxy)hexine-3 and α,α′-bis(t-butylperoxy-m-isopropyl)benzene; diacylperoxides such as octanoylperoxide and isobutyrylperoxide; and peroxyesters such as peroxydicarbonate; can be exemplified. Above all, considering the property of crosslinked resin, dialkylperoxides are preferable; and it is preferable to vary alkyl group according to the forming temperature.

Although crosslinking agents (curing agents) that are effective with heat are not particularly limited if it is possible to cause crosslinking reaction by heat, diamine, triamine and the other aliphatic polyamine, alicyclic polyamine, aromatic polyaminebisazide, acid anhydride, diol, polyhydric phenol, polyamide, diisocyanate and polyisocyanate and the like can be exemplified. As for specific examples, aliphatic polyamines such as hexamethylendiamine, triethylenetetramine, diethylene triamine and tetraethylenepentamine; alicyclic polyamines such as diaminocyclohexane and 3(4),8(9)-bis(aminomethyl)tricycle[5.2.1.0^{2,6}]decane; alicyclic polyamines such as 1,3-(diaminomethyl) cyclohexane, menthanediamine, isophoronediamineN-aminoethylpiperazine, bis(4-amino-3-methylcyclohexyl)methane and bis(4-aminocyclohexyl)methane; aromatic polyamines such as 4,4′-diaminodiphenylether, 4,4′-diaminodiphenylmethane, α,α′-bis(4-aminophenyl)-1,3-diisopropylbenzene, α,α′-bis(4-aminophenyl)-1,4-diisopropylbenzene, 4,4′-diaminodiphenylsulfone and metaphenylenediamine; bisazides such as 4,4′-bisazidbenzal(4-methyl)cyclohexanone, 4,4′-diazidchalcone, 2,6-bis(4′-azidbenzal)cyclohexanone, 2,6-bis(4′-azidbenzal)-4-methyl-cyclohexanone, 4,4′-diazidediphenylsulfone, 4,4′-diazidediphenylmethane and 2,2′-diazidestilbene; anhydrides such as phthalic anhydride, pyromellitic anhydride, benzophenone tetracarboxylic anhydride, nadic anhydride, 1,2-cyclohexane dicarboxylic acid, maleic anhydride modified polypropylene and maleic anhydride modified norbornene resin; dicarboxylic acids such as fumaric acid, phthalic acid, maleic acid, trimellitic acid and himic acid; diols such as 1,3′-butanediol, 1,4′-butanediol, hydroquinonedihydroxydiethylether and tricyclodecanedimethanol; triols such as 1,1,1-trimethylolpropane; polyphenols such as phenol novolac resin and cresol novolac resin; polyalcohols such as tricyclodecanediol, diphenylsilanediol, ethylene glycol and its derivatives, diethylene glycol and its derivatives and triethylene glycol and its derivatives; polyamides such as nylon-6, nylon 66, nylon 610, nylon 11, nylon 612, nylon 12, nylon 46, methoxymethylated polyamide, polyhexamethylenediamineterephthalicamide and polyhexamethyleneisophthalicamide; diisocyanates such as hexamethylenediisocyanate and toluylenediisocyanate; polyisocyanates such as dimer or trimer of diisocyanates and diols or triols of diisocyanate adducts; blocked isocyanates wherein isocyanate is protected by block agent; and the like are exemplified.

These can be used by single or mixing two kinds or more.

Above all, aromatic polyamines, anhydrides, polyhydric phenols, polyhydric alcohols are preferable, because they provide porous film with superior strength and adhesion property. In particular, 4,4-diamino diphenylmethane (aromatic polyamine), maleic anhydride modified norbornene resin (anhydride) and polyhydric phenols are more preferable.

Although crosslinking agents (curing agents) that are effective with light are not particularly limited if they are photoreactive compounds which produce crosslinked compounds by irradiating active light rays including ultraviolet rays, such as g-line, h-line and i-line, far ultraviolet rays, x-ray and electron ray, and reacting with the copolymer of the invention, aromatic bisazide compound, photoamine generating agent, photoacid generating agent are exemplified.

As for aromatic bisazide compounds, 4,4′-diazidechalcone, 2,6-bis(4′-azidbenzal)cyclohexanone, 2,6-bis(4′-azidbenzal)4-methylcyclohexanone, 4,4′-diazidediphenylsulfone, 4,4′-diazidebenzophenone, 4,4′-diazidediphenyl, 2,7-diazidefluorene, 4,4′-diazidephenylmethane are typical examples. These can be used by single or mixing two kinds or more.

As for photoamine generating agent, aromatic amines and aliphatic amines of o-nitrobenzyloxycarbonylcarbamate, 2,6-dinitrobenzyloxycarbonylcarbamate, and α,α-dimethyl-3,5-dimethoxybenzyloxycarbonylcarbamate are typical examples. In particular, o-nitrobenzyloxycarbonylcarbamates of aniline, cyclohexylamine, piperidine, hexamethylendiamine, triethylenetetramine, 1,3-(diaminomethyl)cyclohexane, 4,4′-diaminodiphenylether, 4,4′-diamino diphenylmethane, and phenylenediamine can be exemplified. These can be used by single or mixing two kinds or more.

As for photoacid generating agents, which produce Broensted or Lewis acid by irradiating active light rays, onium salt, halogenated organic compound, quinonediazide compound, α,α-bis(sulfonyl)diazomethane compounds, α-carbonyl-α-sulfonyl-diazomethane compounds, sulfone compound, organic acid ester compound, organic acid amido compound and organic acid imido compound can be exemplified. These compounds, capable of producing acids by cleavage occurred when irradiating active light rays can be used by single or mixing two kinds or more.

Said crosslinking agents can be used by single or mixing two kinds or more. Compounding amount of the crosslinking agents are normally 0.001 to 30 parts by mass, preferably 0.01 to 25 parts by mass, more preferably 1 to 20 parts by mass, per 100 parts by mass of copolymer of the invention. When the compounding amount of crosslinking agents are within said range, properties such as crosslinking property, lithium conductivity of crosslinking material in electrolyte solution, dissolving property of electrolyte solution and strength of porous film are highly balanced, which is preferable.

When using crosslinking agents in the invention, it is preferable to use crosslinking aids (curing aids) which is capable to further improve crosslinking property and dispersibility of compounding agent. Crosslinking aid of the invention is not particularly limited and can be conventionally known aid disclosed in Japanese Laid-open Patent Application (Tokkaishow) No. 62-34924 and the like, oxime.nitroso crosslinking aids such as quinonedioxime, benzoquinonedioxime and p-nitroso phenol; maleimide crosslinking aids such as N,N-m-phenylenebis maleimide; allyl crosslinking aids such as diallylphthalate, trial lylcyanurate, triallylisocyanurate; methacrylate crosslinking aids such as ethyleneglycol dimethacrylate and trimethylolpropane trimethacrylate; vinyl crosslinking aids such as vinyl toluene, ethylvinyl benzene and divinyl benzene; and the like are exemplified. Above all, allyl crosslinking aid and methacrylate crosslinking aid are preferable, in view of that they are capable for uniform dispersion.

Although additive amount of the crosslinking aids can be suitably varied according to the type of crosslinking agent, it is normally 0.1 to 10 parts by mass, preferably 0.2 to 5 parts by mass, per 1 part by mass of crosslinking agent. When the additive amount of crosslinking aid is too small, crosslinking is difficult to occur, to the contrary, when it is too much, there is a risk to reduce lithium conductivity and water resistance of the crosslinked binder.

When thermal crosslinkable group is contained in copolymer forming a binder, said thermal crosslinkable group is preferably at least one kind selected from the group consisting of epoxide group, N-methylolamido group and oxazoline group. Above all, epoxide group can easily control crosslinking and crosslink density, which is preferable.

When preparing said copolymer, thermal crosslinkable group can be introduced into the copolymer by copolymerizing monomer providing (meth)acrylonitrile monomer unit, monomer providing (meth)acrylic ester monomer unit, monomer including thermal crosslinkable group and, if necessary, the other monomer polymerizable with the above monomers.

As for monomer including epoxide group, monomer including carbon-carbon double bond and epoxide group and monomer including halogen atom and epoxide group can be exemplified.

As for monomer including carbon-carbon double bond and epoxide group, unsaturated glycidyl ethers such as vinylglycidyl ether, allylglycidyl ether, butenylglycidyl ether and o-allylphenylglycidyl ether; monoepoxides of diene or polyene such as butadiene monoepoxide, chloroprene monoepoxide, 4,5-epoxy-2-pentene, 3,4-epoxy-l-vinyl cyclohexene and 1,2-epoxy-5,9-cyclododecadiene; alkenyl epoxides such as 3,4-epoxy-i-butene, 1,2-epoxy-5-hexene and 1,2-epoxy-9-decene; glycidylesters of unsaturated carboxylic acid such as glycidyl acrylate, glycidyl methacrylate, glycidyl crotonate, glycidyl-4-heptanoate, glycidyl sorbate, glycidyl linoleate, glycidyl-4-methyl-3-pentenoate, glycidyl ester of 3-cyclohexene carboxylic acid, and glycidyl ester of 4-methyl-3-cyclohexene carboxylic acid can be exemplified.

As for monomer including halogen atom and epoxide group, epihalohydrins such as epichlorohydrin, epibromohydrin, epiiodohydrin, epifluorohydrin and β-methylepichlorohydrin; p-chlorostyrene oxide; and dibromophenylglycidylether can be exemplified.

As for monomer including N-methylolamido group, (meth)acrylamides which include methylol group such as N-methylol(meth)acrylamide can be exemplified.

As for monomer including oxazoline group, 2-vinyl-2-oxazoline, 2-vinyl-4-methyl-2-oxazoline, 2-vinyl-5-methyl-2-oxazoline, 2-isopropenyl-2-oxazoline, 2-isopropenyl-4-methyl-2-oxazoline, 2-isopropenyl-5-methyl-2-oxazoline and 2-isopropenyl-5-ethyl-2-oxazoline can be exemplified.

Thermal crosslinkable group containing amount in the copolymer, namely, thermal crosslinkable group containing monomer amount when polymerizing, is preferably within a range of 0.1 to 10 mass %, more preferably 0.1 to 5 mass %, per 100 mass % of whole unit of monomer. The thermal crosslinkable group containing amount in the copolymer can be controlled by charging rate of monomer when preparing copolymer forming binder. When the thermal crosslinkable group containing amount in the copolymer is within said range, dissolution to electrolyte solution can be prevented and it is possible to obtain superior porous film strength and long term cycle characteristic.

In the invention, it is preferable that copolymer used as binder further comprises at least one kind of hydrophilic group selected from the group consisting of carboxylic group, hydrophilic group and sulfonic group. When copolymer includes said hydroxyl group, dispersion stability of nonconductive particles and binding ability between nonconductive particles can both be improved. Further, since surface of nonconductive particles are likely to show hydrophilic ability, binder is likely to be adsorbed to the surface of nonconductive particles when said binder includes hydrophilic group; and thus, dispersion of nonconductive particles improves and smooth porous film can be obtained on organic separator.

Hydrophilic group is at least one selected from the group consisting of carboxylic group, hydroxyl group and sulfonic group. Above all, sulfonic group and carboxylic group are preferable, because they are capable of improving dispersion and binding ability of nonconductive particles.

When preparing said copolymer, hydrophilic group can be introduced by copolymerizing monomer providing (meth)acrylonitrile monomer unit, monomer providing (meth)acrylic ester monomer unit, monomer including hydrophilic group and, if necessary, the other monomer copolymerizable with the above monomers.

As for monomer including carboxylic group, monocarboxylic acid and its derivatives and dicarboxylic acid and its anhydrides and derivatives can be exemplified.

As for monocarboxylic acid, acrylic acid, methacrylic acid, crotonic acid and the like are exemplified. As for monocarboxylic acid derivatives, 2-ethylacrylic acid, isocrotonic acid, α-acetoxyacrylic acid, β-trans-aryloxyacrylic acid, α-chloro-β-E-methoxyacryalic acid, β-diaminoacrylic acid and the like can be exemplified.

As for dicarboxylic acid, maleic acid, fumaric acid, itaconic acid and the like can be exemplified.

As for dicarboxylic acid anhydrides, maleic acid anhydride, acrylic acid anhydride, methylmaleic acid anhydride, dimethylmaleic acid anhydride and the like can be exemplified.

As for dicarboxylic acid derivatives, maleic derivatives such as methyl maleic acid, dimethyl maleic acid, phenyl maleic acid, chloro maleic acid, dichloro maleic acid, fluoro maleic acid and the like; maleate such as methylallyl maleate, diphenyl maleate, nonyl maleate, decyl maleate, dodecyl maleate, octadecyl maleate, fluoro alkyl maleate and the like can be exemplified.

As for monomer including hydroxyl group, unsaturated ethylenic alcohol such as, (meth)allyl alcohol, 3-buten-1-ol, 5-hexen-1-ol and the like; alkanol esters of unsaturated ethylenic carboxylic acid such as, acrylic acid-2-hydroxyethyl, acrylic acid-2-hydroxypropyl, methacrylic acid-2-hydroxyethyl, methacrylic acid-2-hydroxypropyl, maleic acid-di-2-hydroxyethyl, maleic acid di-4-hydroxybutyl, itaconic acid di-2-hydroxypropyl and the like; esters of polyalkylene glycol and (meth)acrylic acid shown by a generic formula CH₂═CR¹—COO—(CₙH₂ₙO)ₘ—H (m is integral number of 2 to 9, n is integral number of 2 to 4, R¹ is hydrogen or methyl group); mono(meth)acrylate esters of dihydroxy ester of dicarboxylic acid such as 2-hydroxyethyl-2′-(meth)acryloyl oxyphthalate, 2-hydroxyethyl-2′-(meth)acryloyl oxysuccinate and the like; vinyl ethers such as 2-hydroxyethylvinylether, 2-hydroxypropylvinylether and the like; mono(meth)allyl ethers of alkylene glycol such as (meth)allyl-2-hyroxyethyl ether, (meth)aryl-2-hydroxypropyl ether, (meth)allyl-3-hydroxypropyl ether, (meth)allyl-2-hydroxybutyl ether, (meth)allyl-3-hydroxybutyl ether, (meth)allyl-4-hydroxybutyl ether, (meth)allyl-6-hydroxyhexyl ether and the like; polyoxyalkyleneglycol(meth)monoallyl ether such as, diethyleneglycol mono(meth)allyl ether, dipropylene glycolmono(meth)allyl ether and the like; mono(meth)allyl ether of halogen and hydroxy substituent of (poly)alkylene glycol such as, glycerin mono(meth)allyl ether, (meth)allyl-2-chloro-3-hydroxypropyl ether, (meth)allyl-2-hydroxy-3-chloropropyl ether and the like; mono(meth)allyl ethers of polyphenol, such as eugenol, isoeugenol and the like, and halogen substitute thereof; (meth)allylthio ethers of alkylene glycol such as (meth)allyl-2-hydroxyethylthio ether,(meth)allyl-2-hydroxypropylthio ether and the like are exemplified.

Also, as for the monomer comprising sulfonic acid group, vinyl sulfonic acid, methylvinyl sulfonic acid, (meth)allyl sulfonic acid, styrene sulfonic acid, (meth)acrylic acid-2-sufonic acid ethyl, 2-acrylamide-2-methylpropane sulfonic acid, 3-allyloxy-2-hydroxypropane sulfonic acid and the like are exemplified.

Above all, sulfonic group and carboxylic group are preferable, because they are capable of improving dispersion and binding ability of nonconductive particles.

Hydrophilic group containing amount in the copolymer, in terms of hydrophilic group containing monomer amount when polymerizing, is preferably within a range of 0.1 to 40 mass %, more preferably 0.5 to 20 mass %, per 100 mass % of whole unit of monomer. Hydrophilic group containing amount in the copolymer can be controlled by charging rate of monomer when preparing copolymer forming binder. When hydrophilic group containing amount in the copolymer is within said range, a better dispersion of nonconductive particles can be provided.

It is preferable that copolymer used as binder of the invention may include, other than monomer providing (meth)acrylonitrile monomer unit and monomer providing (meth)acrylic ester monomer unit, said hydrophilic group and thermal crosslinkable group. When copolymer includes said hydrophilic group and thermal crosslinkable group, crosslinking density is likely to be improved, and thus, a high-strength porous film can be obtained.

Copolymer used as binder of the invention may include, other than said monomers, monomers coporimarizable with said monomers. As for the other monomers coporimarizable with said monomers, styrene type monomer such as styrene, chlorostyrene, vinyl toluene, t-butyl styrene, methyl vinyl benzonate, vinyl naphthalene, chloromethyl styrene, a-methyl styrene, divinylbenzene and the like; olefins such as ethylene, propylene and the like; diene type monomer such as butadiene, isoprene and the like; halogen atoms containing monomer such as vinyl chloride, vinylidene chloride and the like; vinyl esters such as vinyl acetate, vinyl propionate, vinyl butyrate and the like; vinyl ethers such as methylvinyl ether, ethylvinyl ether, butylvinyl ether and the like; vinyl ketones such as methylvinyl ketone, ethylvinyl ketone, butylvinyl ketone, hexylvinyl ketone, isopropenylvinyl ketone and the like; heterocycle ring containing vinyl compounds such as N-vinyl pyrolidone, vinyl pyridine, vinyl imidazole and the like; amide type monomer such as acrylamide, N-methylol acrylamide, acrylamide-2-methyl propane sulfonic acid and the like can be exemplified.

Manufacturing methods of said copolymer is not particularly limited, and any method such as solution polymerization method, suspension polymerization method, bulk polymerization method, emulsion polymerization method, and the like can be used. As for polymerization method, any method such as ion polymerization, radical polymerization, living radical polymerization method, and the like can be used. As for polymerization initiator used for polymerization, for example, organic peroxide such as lauroyl peroxide, diisopropyl peroxydicarbonate, di-2-ethylhexyl peroxydicarbonate, t-butyl peroxypivalate, 3,3,5-trimethyhexanoil peroxide and the like, azo compound such as α,α′-azobisisobutylnitrile and the like, or ammonium persulfate, potassium persulfate and the like can be exemplified.

In the invention, glass-transition temperature of said copolymer used as binder is preferably 15° C. or less and more preferably 0° C. or less, in view of that softness can be provided to porous film at room temperature and also cracks when roll winding or rolling up and chips of porous film can be prevented. Glass-transition temperature of said copolymer can be suitably varied according to rate of monomers used when forming copolymer.

Content amount of binder in porous film is preferably within a range of 0.1 to 10 mass %, more preferably 0.5 to 5 mass %, the most preferably 0.5 to 3 mass %. When content of binder in porous film is within said range, it is capable of maintaining binding ability between nonconductive particles and binding ability to organic separator and softness, without disturbing Li movement, and preventing increase of resistance.

In the porous film, the other component such as dispersing agent, leveling agent, deforming agent and electrolyte solution additives, functional to prevent decomposition of electrolyte solution, may be included. These are not particularly limited if it does not influence to battery reaction.

As for dispersing agent, anionic compound, cationic compound, non-ionic compound and polymer compound are exemplified. Said dispersing agent can be selected according to nonconductive particles used. Content amount of dispersing agent in porous film is preferably outside of a range which affects battery property, and 10 mass % or less, in particular.

As for leveling agent, surface active agents such as alkyl type surface active agent, silicone type surface active agent, fluorine type surface active agent, metal type surface active agent and the like are exemplified. By mixing said surface active agent, repellent at coating process can be prevented and smoothness of an electrode can be improved. As for other components, nanoparticulate such as fumed silica, alumina and the like are exemplified. By mixing said nanoparticulate, thixotropy of the slurry for forming porous film can be controlled, leveling property of the obtained porous film can be improved further thereby.

Content amount of leveling agent in porous film is preferably outside of a range which affects battery property, and 10 mass % or less, in particular.

### Manufacturing Method of A Separator For Lithium-Ion Secondary Battery

As for manufacturing method of a separator for lithium-ion secondary battery of the invention, 1) coating the below mentioned slurry for porous film on organic separator, and drying the same; 2) immersing organic separator to the below mentioned slurry for porous film, and drying the same; 3) coating the below mentioned slurry for porous film on a release film, making a film, then the obtained porous film is transferred to an organic separator; and the like are exemplified. Above all, 1) coating slurry for porous film on organic separator, and drying the same is likely to control film thickness of the porous film, which is the most preferable.

A manufacturing method of a separator for lithium ion secondary battery of the invention is characterized by comprising; coating slurry for porous film comprising nonconductive particles, binder including copolymer comprising (meth)acrylonitrile monomer unit and (meth)acrylic ester monomer unit, and solvent on organic separator, and drying the same.

Slurry for porous film of the invention comprises nonconductive particles, binder including copolymer comprising (meth)acrylonitrile monomer and (meth)acrylic ester monomer, and solvent.

As for nonconductive particles and binder, examples defined in the above porous film are used.

The solvent is not particularly limited if it is possible to uniformly disperse the above-mentioned solid contents (nonconductive particles and binder).

As for the solvent used for slurry for porous film, either water or organic solvent can be used. As for the organic solvent, aromatic hydrocarbons such as benzene, toluene, xylene, ethylbenzene and the like, chlorinated aliphatic hydrocarbon such as methylenechloride, chloroform, carbon tetrachloride and the like are exemplified. For the other solvent, pyridine, acetone, dioxane, dimethyl formamide, methylethyl ketone, diisopropyl ketone, cyclohexanone, tetrahydrofuran, n-butyl phthalate, methyl phthalate, ethyl phthalate, tetrahydrofurfuryl alcohol, ethyl acetate, butyl acetate, 1-nitropropane, carbon disulfide, tributyl phosphate, cyclohexane, cyclopentane, xylene, methylcyclohexane, ethylcyclohexane, N-methyl pyrolidone and the like are exemplified. These solvents can be used by single or mixture solvent.

These solvent can be used by single or mixture mixing two kinds or more. Above all, solvent having a superior dispersibility of nonconductive particles, a low boiling point and a high volatility is preferable, in view of that the solvent can be removed in a short time at a low temperature. Specifically, acetone, cyclohexanone, cyclopentane, tetrahydrofuran, cyclohexane, xylene, water, N-methyl pyrolidone and a mixture solvent of these are preferable. Further, cyclohexanone, xylene, N-methyl pyrolidone and a mixture solvent of these are more preferable, in view of that, they have a low volatility and excellent working ability in slurry coating process.

Although solid content concentration of the slurry for porous film is not particularly limited unless capable to perform the above coating and immersion, and has viscosity which shows fluidity, it is normally 20 to 50 mass % and the like.

Manufacturing method of slurry for porous film of the invention is not particularly limited and can be obtained by mixing nonconductive particles, binder including copolymer comprising (meth)acrylonitrile monomer unit and (meth)acrylic ester monomer unit, solvent and the other component added when necessary.

As a mixing apparatus, it is not particularly limited if the above-mentioned components can be mixed uniformly, and a ball mill, a sand mill, a pigment dispersing machine, a grinder, an ultrasonic dispersion machine, a homogenizer, a planetary mixer can be used; in particular, it is preferable to use a high dispersion machine such as a bead mill, a roll mill, Fill mix and the like which is capable to provide high dispersion share. Slurry viscosity in the state of slurry for porous film is in a range of 50 mPa·S to 10,000 mPa·S, preferably 50 to 500 mPa·S, in view of uniform coating and tempostability of the slurry. Said viscosity is a value when it is measured at 25° C. and rotation speed 60 rpm by using B type viscometer.

A method for coating the slurry for porous film on the organic separator is not particularly limited. For example, the doctor blade method, the dip method, the revers roll method, the direct roll method, the gravure method, the extrusion method, the brush application method and the like are exemplified. In these, the dip method and gravure method are preferable in view of that a uniform porous film can be obtained. As for the drying method, for example, drying by warm air, hot air, low humid air, vacuum drying, drying methods by irradiating (far) infrared radiation, electron beam and the like are exemplified. The drying temperature is changed according to a kind of used solvent. For example, for removing the solvent completely, in case of using solvent having low volatility such as N-methylpyrrolidone and the like, it is preferable to dry by a blow dryer at high temperature of 120° C. or more. Contrary to this, in case of using solvent having high volatility, it can be dried at a low temperature of 100° C. or less.

A thickness of the obtained porous film is not particularly limited, and can be set appropriately in accordance with a kind of the lithium ion secondary battery where the porous membrane is used. When it is too thin, a uniform film cannot be formed, also when it is too thick, a capacity per volume (mass) in the battery is decreased, therefore 0.1 to 50 μm is preferred, 0.2 to 10 μm is more preferred and 0.5 to 10 μm is the most preferred.

Porous film formed on organic separator is manufactured by binding nonconductive particles with binder and has a structure wherein voids are formed between nonconductive particles. Electrolyte solution is capable of penetrating in said voids; therefore, battery reaction is not inhibited.

In the invention, surface of organic separator wherein porous film is formed is not particularly limited. The porous film may be formed on any surface of positive electrode and negative electrode of the secondary battery, and it can also be formed on both surfaces of positive and negative electrodes.

### Lithium Ion Secondary Battery

A lithium ion secondary battery of the invention comprises a positive electrode, a negative electrode, an electrolyte solution and separator; and said separator is the separator for the lithium ion secondary battery of the invention

The positive and the negative electrodes are generally composed of electrode active material layer, essentially including electrode active material, adhered to a collector.

### Electrode Active Material

For the electrode active material used for lithium ion secondary battery, any compounds can be used if it is available to charge and discharge lithium ion reversibly by applying electric potential in electrolyte, and inorganic and organic compounds may be used.

An electrode active material for positive electrode (positive electrode active material) of the lithium ion secondary battery is classified into two broad categories, namely of inorganic compound and organic compound. As for the positive electrode active material, transition metal oxide, complex oxide of lithium and transition metal, transition metal sulphide and the like are exemplified. As for the above-mentioned transition metal, Fe, Co, Ni, Mn and the like are used. As specific examples of the inorganic compound used for the positive electrode active material, lithium containing complex metal oxides such as LiCoO₂, LiNiO₂, LiMnO₂, LiMn₂O₄, LiFePO₄, LiFeVO₄ and the like, transition metal sulphide such as TiS₂, TiS₃, amorphous MoS₂ and the like, transition metal oxides such as Cu₂V₂O₃, amorphous V₂O—P₂O₅, MoO₃, V₂O₅, V₆O₁₃ and the like are exemplified. These compounds may be subjected to elemental substitution partially. As for the positive electrode active material composed of the organic compound, conductive polymers such as polyacetylene, poly-p-phenylene and the like can be exemplified. Ferrous oxide which has poor electric conductivity may be used as an electrode active material covered with a carbon material by reduction firing under the presence of a carbon source. Also, these compounds may be subjected to elemental substitution partially.

A positive electrode active material for the lithium ion secondary battery may be a mixture of the above-mentioned inorganic compounds and organic compounds. Although a particle diameter of the positive electrode active material is suitably selected in view of balance with other constitutional element of the battery, 50% accumulated volume diameter is normally 0.1 to 50 μm, preferably 1 to 20 μm, in view of improving battery property, such as a load property and cyclic property. When the 50% accumulated volume diameter is within this range, a secondary battery having large discharge and charge amount can be obtained, and it is easy for handling when producing the slurry for electrode and coating the slurry to form electrode. The 50% accumulated volume diameter can be determined by measuring particle size distribution with laser diffraction.

As for an electrode active material for a negative electrode (negative electrode active material) of the lithium ion secondary battery, carbonaceous materials such as, amorphous carbon, graphite, natural graphite, meso carbon micro beads, pitch base carbon fiber and the like, conductive polymer such as polyacene and the like can be exemplified. Also, as for the negative electrode active material, metals such as silicon, tin, zinc, manganese, iron, nickel, and alloys thereof, oxides, sulfates of said metals or alloys thereof are used. Additionally, metallic lithium, lithium alloy such as Li—Al, Li—Bi—Cd, Li—Sn—Cd and the like, lithium transitional metal nitrides, silicon and the like can be used. An electrode active material on which conductivity improver is adhered by a mechanical modifying method can be used also. Although a particle diameter of the negative electrode active material is suitably selected in view of balance with other constitutional element of the battery, 50% accumulated volume diameter is normally 1 to 50 μm, preferably 15 to 30 μm, in view of improving battery properties, such as initial efficiency, a load property and cyclic property.

In the invention, electrode active material layer preferably includes binder (hereinafter sometimes referred as “binder for active material layer”) other than electrode active material. When binder for active material layer is included, binding ability of electrode active material layer in electrode improves; strength to mechanical force, acting in a process of rolling up the electrode, increases; and further, electrode active material layer in electrode becomes difficult to be removed, therefore, there will be a small risk for short-circuit caused by removed materials.

As for the binder for active material layer, various resin components can be used. For example, polyethylene, polytetrafluoroethylene (PTFE), polyvinylidene fluoride (PVDF), tetrafluoroethylene-hexafluoropropylene copolymer (FEP), polyacrylic acid derivative, polyacrylonitrile derivative and the like can be used. They can be used by single or combination of two or more kinds.

Further, soft polymers exemplified below can be used as binder for active material layer.

Acrylic type soft polymer, which is homopolymer of acrylic acid or methacrylic acid derivatives or copolymer of said homopolymer and a monomer copolymerizable therewith, such as polybutylacrylate, polybutylmethacrylate, polyhydroxyethyl methacrylate, polyacrylamide, polyacrylonitrile, butylacrylate/styrene copolymer, butylacrylate/acrylonitrile copolymer, butylacrylate/acrylonitrile/glycidylmethacrylate copolymer and the like;

isobutylene type soft polymer such as polyisobutylene, isobutylene/isoprene rubber, isobutylene/styrene copolymer and the like;

diene type soft polymer, such as polybutadiene, polyisoprene, butadiene/styrene random copolymer, isoprene/styrene random copolymer, acrylonitrile/butadiene copolymer, acrylonitrile/butadiene/styrene copolymer, butadiene/styrene block copolymer, styrene/butadiene/styrene block copolymer, isoprene/styrene block copolymer, styrene/isoprene/styrene block copolymer and the like;

silicon containing soft copolymer such as dimethyl polysiloxane, diphenyl polysiloxane, dihydroxy polysiloxane and the like;

olefinic soft polymer such as liquid polyethylene, polypropylene, poly-1-butene, ethylene/α-olefin copolymer, propylene/α-olefin copolymer, ethylene/propylene/diene copolymer (EPDM), ethylene/propylene/styrene copolymer and the like;

vinyl type soft polymer such as polyvinyl alcohol, polyvinyl acetate, polyvinyl stearate, vinyl acetate/styrene copolymer and the like;

epoxy type soft polymer such as polyethylene oxide, polypropylene oxide, epichlorohydrin rubber and the like;

fluorine containing soft polymer such as vinylidene fluoride rubber, polytetra-fluoroethylene-propylene rubber and the like;

other soft polymer such as natural rubber, polypeptide, protein, polyester type thermoplastic elastomer, vinyl chloride type thermoplastic elastomer, polyamide type thermoplastic elastomer and the like are exemplified. These soft polymers may contain crosslinking structure, and functional groups may be added by modification.

Amount of binder for active material layer in electrode active material layer is preferably 0.1 to 5 parts by mass, more preferably 0.2 to 4 parts by mass, particularly preferably 0.5 to 3 parts by mass per 100 parts by mass of the electrode active material. When amount of binder for active material layer in electrode active material layer is within the above range, disengagement of the active material from the electrode can be prevented without inhibiting battery reaction.

The binder for active material layer is prepared as solution or dispersion liquid for producing the electrode.

Viscosity at this time is normally in a range of 1 mPa·S to 300,000 mPa·S, preferably 50 mPa·S to 10,000 mPa·S. Said viscosity is a value when it is measured at 25° C. and rotation speed 60 rpm by using B type viscometer.

In the invention, electrode active material layer may include conductivity improver or reinforcement material. As for the conductivity improver, conductive carbon such as, acetylene black, ketchen black, carbon black, graphite, vapor phase growth carbon fiber, carbon nanotube and the like can be used. Carbon powder such as graphite, fiber and foil of various metals are also exemplified. As for reinforcement material, various organic and inorganic spherical type, plate type, rod type and fiber type filler can be used. By using the conductivity improver, electric contact of each electrode active materials can be improved which contribute to improve discharge rate property when used to a lithium ion secondary battery. Amount of the conductivity improver is normally 0 to 20 parts by mass, preferably 1 to 10 parts by mass per 100 parts by mass of the electrode active material.

The electrode active material layer may be used alone but it is adhered to a collector.

The electrode active material layer is formed by adhering slurry (hereinafter sometimes referred as “composite material slurry”), including electrode active material and solvent, to a collector.

when binder for active material layer is included in electrode active material layer, solvent capable to dissolve said binder or disperse the same finely may be used, however, the solvent capable to dissolve said binder is preferable. When the solvent capable to dissolve said binder for active material layer is used, binder for active material layer adheres on a surface stabilizing the dispersion of electrode active material.

Normally, the composite material slurry contains solvent to disperse the electrode active material, binder for active material layer and conductivity improver. As for the solvent, it is preferable to use solvent which is capable to dissolve said binder, because it has excellent dispersibility for the electrode active material and conductivity improver. It is expected that, the binder for active material layer is adhered on a surface of the electrode active material and the like to thereby stabilize the dispersion by its volume effect when using the binder for active material layer dissolved in the solvent.

As for the solvent used for the composite material slurry, either water or organic solvent can be used. As for the organic solvent, cycloaliphatic hydrocarbons, such as cyclopentane, cyclohexane and the like; aromatic hydrocarbons such as toluene, xylene and the like, ketones such as ethyl methyl ketone, cyclohexanone and the like, esters such as ethylacetate, butylacetate, y-butyrolactone, ε-caprolactone and the like; acylonitriles such as acetonitrile, propionitrile and the like; ethers such as tetrahydrofuran, ethyleneglycoldiethylether and the like; alcohols such as methanol, ethanol, isopropanol, ethylene glycol, ethyleneglycolmonomethylether and the like; amides such as N-methylpyrrolidone, N,N-dimethyl formamide and the like are exemplified. These solvents can be used suitably selected in view of drying speed and environment by single or mixing two kinds or more. In the present embodiment, it is preferable to use nonaqueous solvent, in view of swelling characteristic of the electrode to water.

Additives such as viscosity improver can be added to the composite material slurry by which various functions can be realized. As for the viscosity improver, polymer soluble in the organic solvent used for the composite material slurry is used. Specifically, acrylonitrile-butadiene copolymer hydride and the like are used.

Further, trifluoropropylene carbonate, vinylene carbonate, catechol carbonate, 1,6-dioxaspiro[4,4]nonane-2,7-dione, 12-crown-4-ether and the like can be used for the composite material slurry, in order to improve stability and life duration of the battery. Also, these can be used as included in the after-mentioned electrolyte solution.

Amount of the organic solvent in the composite material slurry is adjusted so as to be an appropriate viscosity for coating in accordance with kinds of the electrode active material, binder, and the like. Specifically, the concentration of solid content, mixed by the electrode active material, binder and other additives, in composite material slurry is adjusted at, preferably 30 to 90 mass %, further preferably 40 to 80 mass %.

The composite material slurry is obtained by mixing electrode active material, binder for active material layer to be added in accordance with necessity, conductivity improver, the other additive agents, and organic solvent by using a blender. As for the blending, the above-mentioned respective components can be supplied into the blender together and mixed. When using electrode active material, binder for active material layer, conductivity improver and viscosity improver as components of composite material slurry, such method that the conductivity improver and viscosity improver are mixed in the organic solvent so as to disperse the conductive material finely, then the binder for active material layer and the electrode active materials are added and further mixed is preferable, in view of improving dispersibility of the slurry. As for the mixing machine, although a ball mill, sand mill, a pigment dispersing machine, a grinder, an ultrasonic dispersion machine, a homogenizer, a planetary mixer and Hobart mixer can be used. The ball mill is preferred because aggregation of the conductive material and the electrode active material can be prevented.

Granularity of the composite material slurry is preferably 35 μm or less, further preferably 25 μm or less. When the granularity of the slurry is within the above-mentioned range, uniform electrode having high dispersibility of the conductive material can be obtained.

Although a collector is not particularly limited if it has electric conductivity and electrochemical durability, in view of having heat resistance, for example, metallic material such as Fe, Cu, Al, Ni, Stainless steel, Ti, Ta, Au, Pt and the like are preferable. In particular, Al is preferable for a positive electrode of nonaqueous electrolyte lithium ion secondary battery, and Cu is particularly preferable for a negative electrode. Although a shape of the collector is not particularly limited, a sheet having about 0.001 to 0.5 mm thickness is preferable. The collector is preferably subjected to surface roughening treatment in advance, for improving binding strength of the composite material. As for a method for roughening surface, mechanical polishing, electropolishing, chemical polishing and the like are exemplified. In the mechanical polishing, a coated abrasive in which abrasive particles are adhered, a grind stone, an emery wheel, a wire brush provided with steel wire and the like are used. Also, in order to improve bonding strength and conductivity of the electrode composite material layer, an intermediate layer may be formed on a surface of the collector.

A method for manufacturing the electrode active material layer may be any methods which can adhere the electrode active material layer in the form of lamina on at least one surface, preferably on both surfaces of the collector. For example, said composite material slurry is coated on the collector and is dried, then heat applied for more than one hour at 120° C. or more so as to form the electrode active material layer. Although a method for coating the composite material slurry to the collector is not limited, a doctor blade method, a dip method, a reverse roll method, a direct roll method, a gravure method, an extrusion method, a brush application method and the like are exemplified. As for the drying method, for example, drying by warm air, hot air and low humid air, vacuum drying, drying methods by irradiating (far) infrared radiation, electron beam and the like are exemplified.

Next, a porosity of the composite material electrode is preferably lowered by pressure treatment with using mold press, roll press and the like. A preferable range of the porosity is 5% to 15%, further preferably 7% to 13%. When the porosity is too high, charging efficiency and discharge efficiency are deteriorated. When the porosity is too low, problems that it is hard to obtain a high volume capacity, defect due to easily peeling the composite material are occurred. Further, when using curable polymer, it is preferable to perform curing.

A thickness of the electrode active material layer is normally 5 to 300 μm, preferably 10 to 250 μm for both positive and negative electrodes.

### Electrolyte Solution

As for the electrolyte solution, an organic electrolyte solution wherein supporting electrolyte is solved in the organic solvent is used. As for the supporting electrolyte, lithium salt is used. As for the lithium salt, although there is no limitation particularly, LiPF₆, LiAsF₆, LiBF₄, LiSbF₆, LiAlCl₄, LiClO₄, CF₃SO₃Li, C₄F₉SO₃Li, CF₃COOLi (CF₃CO) ₂NLi, (CF₃SO₂)₂NLi, (C₂F₅SO₂)NLi are exemplified. In particular, LiPF₆, LiClO₄, CF₃SO₃Li which are easily soluble to solvent and show high dissociation degree are preferred. They may be used as combination of two kinds or more. Because the supporting electrolyte having high dissociation degree is used to make the lithium ion conductivity higher, the lithium ion conductivity can be controlled by a kind of supporting electrolyte.

Although the organic solvent used for the electrolyte solution is not particularly limited if it is possible to dissolve the supporting electrolyte, carbonates such as dimethyl carbonate (DMC), ethylene carbonate (EC), diethyl carbonate (DEC), propylene carbonate (PC), butylene carbonate (BC), methylethyl carbonate (MEC) and the like; esters such as y-butyrolactone, methyl formate and the like; ethers such as 1,2-dimethoxyethane, tetrahydrofuran and the like; sulfur-containing compounds such as sulfolane, dimethyl sulfoxide and the like are used preferably. Also, mixture liquids of these solvents may be used. In particular, carbonates are preferable, since they have high conductivity and wide stable potential area. When the viscosity of the used solvent is low, the lithium ion conductivity becomes higher, hence the lithium ion conductivity can be controlled by a kind of the solvent.

Concentration of the supporting electrolyte in the electrolyte solution is normally 1 to 30 mass %, preferably 5 mass % to 20 mass %. Also, in accordance with kinds of the supporting electrolyte, it is used at concentration of 0.5 to 2.5 mol/L normally. When either the concentration of the supporting electrolyte is too low or too high, the ion conductivity tends to be decreased. When the concentration of the used electrolyte is low, a swelling degree of the polymer particle becomes larger, hence the lithium ion conductivity can be controlled by a concentration of the electrolyte solution.

As for a specific manufacturing method for the lithium ion secondary battery, for example, a method wherein positive electrode and a negative electrode are overlapped via a separator of the invention, the resulting laminate is inputted to a battery container by rolling or folding in accordance with a battery shape, and filling electrolyte solution to the battery container and sealing is exemplified. Separator of the invention is formed by coating porous film either on both sides or one side of the separator. Also, it is possible to prevent pressure rising of inside of the battery, over charge and discharge by inputting over-current protective elements such as expand metal, fuse, PTC elements and the like, a lead plate and the like, in accordance with necessity. A shape of the battery may be any of a coin type, a button type, a sheet type, a cylindrical type, a square type, a flat type and the like.

### EXAMPLES

Below, although the present invention will be explained with showing an example, the present invention is not limited thereto. Note that, part and % in this example are by mass unless otherwise indicated.

In examples and comparative examples, various physical properties are evaluated as follows.

### Deformation Property of Separator

Slurry for porous film was coated on single layer polypropylene made separator of 65 mm width×500 mm length×25 μm thickness manufactured by drying method, then dried for 20 minutes under 90° C. to obtain separator with porous film. Presence of wrinkles on said separator with porous film was visually observed. This observation was made to ten test pieces, and when number of test piece wherein wrinkles were observed was one or less, it was considered A, when two to four, B, and when five or more, C.

Further, length “a”(mm) of the dried separator with porous film was measured, and deformation rate (=a/500×100) % of said separator was obtained. When deformation rate of separator was 98% or more, it was determined A, when 95% or more and less than 98%, B, when 90% or more and less than 95%, C, and when less than 90%, D. When the deformation rate of the separator is higher, deformation of the separator is smaller, showing excellent smoothness of an electrode.

### Dispersibility of Inorganic Particles In Slurry For Porous Film

Dispersed particle diameter of inorganic particles in slurry for porous film was measured by laser diffraction particle size distribution measurement device; and mean volume particle diameter D50 was obtained. Dispersibility was determined by the following criteria. When the dispersed particle diameter is closer to initial particle (mean volume particle diameter of inorganic particles), the aggregation is smaller, showing progress of dispersion.
A: less than 0.5 μm
B: 0.5 μm or more to less than 1.0 μm
C: 1.0 μm or more to less than 2.0 μm
D: 2.0 μm or more to less than 5.0 μm
E: 5.0 μm or more

### Cyclic Property

With coin type battery of 10 cells, charge and discharge, including charging to 4.3V by 0.2 C of constant current method and discharging to 3.0V, was repeated; and electric capacity was measured. An average value of 10 cells was considered a measurement value; and the discharge and charge capacity retention rate, shown by rate (%) of electric capacity after 50 cycles and the same after 5 cycles, was calculated, and was determined by following criteria. When this value is larger, long term cycle characteristic is superior.
A: 80% or more
B: 70% or more to less than 80%
C: 60% or more to less than 70%
D: 50% or more to less than 60%
E: 40% or more to less than 50%
F: 30% or more to less than 40%
G: less than 30%

### Example 1

### Manufacturing Method of Polymer

300 parts of ion exchange water, 41 parts of n-butyl acrylate, 41.5 parts of ethyl acrylate, 15 parts of acrylonitrile, 2.0 parts of glycidylmethacrylate, 0.5 parts of 2-acrylamide2-methylpropanesulfonic acid, 0.05 parts of t-dodecylmercaptan as molecular weight modifier, 0.3 parts of potassium persulfate as polymerization initiator were added into an autoclave equipped with an agitator, agitated sufficiently, then polymerized by heating to 70° C.; and polymer particle water dispersion was obtained. A polymerization conversion rate measured from solid content concentration was close to 99%. 320 parts of N-methylpyrrolidone (hereinafter sometimes referred as “NMP”) was added to 100 parts of the polymer particle water dispersion, NMP solution of copolymer (hereinafter referred as “polymer A”) was prepared by distilling water under reduced pressure. Solid content concentration of polymer “A” solution was 8 mass %. Glass transition temperature of polymer “A” was −5° C. Ratio of (meth)acrylonitrile monomer unit and (meth)acrylic ester monomer unit (=(meth)acrylonitrile monomer unit/(meth)acrylic ester monomer unit) in polymer “A” was 15/82.5. Total content ratio of (meth)acrylonitrile monomer unit and (meth)acrylic ester monomer unit was 97.5%. Content ratio of thermal crosslinking group (epoxy group) , in terms of ratio of monomer (glycidyl methacrylate) including thermal crosslinking group, was 2%. Content ratio of hydrophilic group (sulfonic acid group), in terms of ratio of monomer (2-acrylamide 2-methylpropanesulfonic acid) including hydrophilic group, was 0.5%.

### Manufacturing Slurry For Porous Film

Inorganic particles (alumina, 0.3 μm mean volume particle diameter) and polymer “A” were blended by 100:3 (a solid content mass ratio) and 40%, in terms of solid content, of N-methylpyrrolidone was further blended, then, slurry “1” for porous film was prepared by dispersing with a bead mill. Dispersed particle diameter of the obtained porous film slurry “1” was measured. The results are shown in Table 1.

### Manufacturing Separator For Porous Film

The slurry “1” for porous film was coated on one side of single layer polypropylene made separator of 65 mm width×500 mm length×25 μm thickness (porosity 55%), manufactured by drying method, by using wire bar so that the thickness after drying was 10 μm; then dried for 20 minutes under 90° C. to form porous film, and separator “1” with porous film was obtained. Deformation property of the obtained separator “1” with porous film was evaluated. The results are shown in Table 1.

### Manufacturing Negative Electrode

98 parts of graphite having particle size of 20 μm, 4.2m²/g of specific surface area as a negative electrode active material and 1 part, in terms of solid content, of SBR (−10° C. glass transition temperature) as binder for active material layer were blended, further, 1 part of carboxymethylcellulose (CMC) was added and blended by a planetary mixer so that slurry type electrode composition for a negative electrode (composite material slurry for negative electrode) was prepared. The negative electrode composition was coated on one surface of a copper foil having 0.01 mm thickness, dried for 3 hrs at 120° C., and was roll-pressed to thereby obtained a negative electrode active material layer having 80 μm thickness.

### Manufacturing Battery

The obtained negative electrode was cut to be a circular shape having 13 mmΦ diameter, lithium metal foil having 0.5 mm thickness was cut to be a circular shape having 16 mmΦ diameter, and the obtained separator with porous film was cut to be a circular shape having 18 mmΦ diameter. A separator “1” with porous film and lithium metal film as the positive electrode were sequentially laminated on a surface of active material layer side of the negative electrode, and was inserted into a coin type external container made of stainless steel provided with a packing made of polypropylene. Note that a separator “1” with porous film was laminated in order that the porous film layer was laminated on active material layer side of negative electrode. Electrolyte solution (EC/DEC=1/2, 1M of LiPF₆) was injected into the container without residual air, fixed by a cap made of stainless steel having 0.2 mm thickness via the polypropylene made packing to seal a battery case, thereby a lithium ion secondary battery having 20 mm diameter and about 3.2 mm thickness was produced (coin cell CR2032). Cyclic property of the obtained battery was measured. Results are shown in Table 1.

### Example 2

300 parts of ion exchange water, 51 parts of n-butyl acrylate, 41.5 parts of ethyl acrylate, 5 parts of acrylonitrile, 2.0 parts of glycidylmethacrylate, 0.5 parts of 2-acrylamide2-methylpropanesulfonic acid, 0.05 parts of t-dodecylmercaptan as molecular weight modifier, 0.3 parts of potassium persulfate as polymerization initiator were added into an autoclave equipped with an agitator, agitated sufficiently, then polymerized by heating to 70° C.; and polymer particle water dispersion was obtained. A polymerization conversion rate measured from solid content concentration was close to 99%. 320 parts of NMP was added to 100 parts of the polymer particle water dispersion, NMP solution of copolymer (hereinafter referred as “polymer B”) was prepared by distilling water under reduced pressure. Solid content concentration of polymer “B” solution was 8 mass %. Glass transition temperature of polymer “B” was −25° C. Ratio of (meth)acrylonitrile monomer unit and (meth)acrylic ester monomer unit (=(meth)acrylonitrile monomer unit/(meth)acrylic ester monomer unit) in polymer “B” was 5/92.5. Total content ratio of (meth)acrylonitrile monomer unit and (meth)acrylic ester monomer unit was 97.5%. Content ratio of thermal crosslinking group (epoxy group), in terms of ratio of monomer (glycidyl methacrylate) including thermal crosslinking group, was 2%. Content ratio of hydrophilic group (sulfonic acid group), in terms of ratio of monomer (2-acrylamide 2-methylpropanesulfonic acid) including hydrophilic group, was 0.5%.

Except for changing polymer “A” to polymer “B” for the binder, slurry “2” for porous film, separator “2” with porous film and battery were prepared as is the same with Example 1. And dispersibility of inorganic particles in slurry “2” for porous film, separator deformation property of separator “2” with porous film, and battery cyclic property were evaluated. Results are shown in table 1.

### Example 3

300 parts of ion exchange water, 83 parts of n-butyl acrylate, 15 parts of acrylonitrile, 2.0 parts of glycidylmethacrylate, 0.05 parts of t-dodecylmercaptan as molecular weight modifier, 0.3 parts of potassium persulfate as polymerization initiator were added into an autoclave equipped with an agitator, agitated sufficiently, then polymerized by heating to 70° C.; and polymer particle water dispersion was obtained. A polymerization conversion rate measured from solid content concentration was close to 99%. 320 parts of NMP was added to 100 parts of the polymer particle water dispersion, NMP solution of copolymer (hereinafter referred as “polymer C”) was prepared by distilling water under reduced pressure. Solid content concentration of polymer “C” solution was 9 mass %. Glass transition temperature of polymer “C” was −15° C. Ratio of (meth)acrylonitrile monomer unit and (meth)acrylic ester monomer unit (=(meth)acrylonitrile monomer unit/(meth)acrylic ester monomer unit) in polymer “C” was 15/83. Total content ratio of (meth)acrylonitrile monomer unit and (meth)acrylic ester monomer unit was 98%. Content ratio of thermal crosslinking group (epoxy group), in terms of ratio of monomer (glycidyl methacrylate) including thermal crosslinking group, was 2%. Content ratio of hydrophilic group was 0%.

Except for changing polymer “A” to polymer “C” for the binder, slurry “3” for porous film, separator “3” with porous film and battery were prepared as is the same with Example 1. And dispersibility of inorganic particles in slurry “3” for porous film, separator deformation property of separator “3” for porous film, and battery cyclic property were evaluated. Results are shown in table 1.

### Example 4

300 parts of ion exchange water, 84.5 parts of ethyl acrylate, 15 parts of acrylonitrile, 0.5 parts of allylglycidylether, 0.05 parts of t-dodecylmercaptan as molecular weight modifier, 0.3 parts of potassium persulfate as polymerization initiator were added into an autoclave equipped with an agitator, agitated sufficiently, then polymerized by heating to 70° C.; and polymer particle water dispersion was obtained. A polymerization conversion rate measured from solid content concentration was close to 99%. 320 parts of NMP was added to 100 parts of the polymer particle water dispersion, NMP solution of copolymer (hereinafter referred as “polymer D”) was prepared by distilling water under reduced pressure. Solid content concentration of polymer “D” solution was 10 mass %. Glass transition temperature of polymer “D” was 2° C. Ratio of (meth)acrylonitrile monomer unit and (meth)acrylic ester monomer unit (=(meth)acrylonitrile monomer unit/(meth)acrylic ester monomer unit) in polymer “B” was 15/84.5. Total content ratio of (meth)acrylonitrile monomer unit and (meth)acrylic ester monomer unit was 99.5%. Content ratio of thermal crosslinking group (epoxy group), in terms of ratio of monomer (allylglycidyl ether) including thermal crosslinking group, was 0.5%. Content ratio of hydrophilic group was 0%.

Except for changing polymer “A” to polymer “D” for the binder, slurry “4” for porous film, separator “4” with porous film and battery were prepared as is the same with Example 1. And dispersibility of inorganic particles in slurry “4” for porous film, separator deformation property of separator “4” for porous film, and battery cyclic property were evaluated. Results are shown in table 1. Cyclic property of Example 4 does not have practical issue; however, it is inferior to the same of Examples 1 to 3.

### Comparative Examples 1 To 4

Except for changing polymer “A” to a polymer described in table 1 as the binder for porous film, slurry for porous film, separator with porous film and battery were prepared as is the same with Example 1. And dispersibility of inorganic particles in the obtained slurry for porous film, separator deformation property of the obtained separator for porous film, and battery cyclic property were evaluated. Results are shown in table 1.

Note that in table 1, “PBA” refers to polybutylacrylate, “PEO” refers to polyethylene oxide, “PVDF” refers to polyvinylidene fluoride, and “PAN” refers to polyacrylonitril.

TABLE 1

| | | deformation of | | | |
|---|---|---|---|---|---|
| | | separator | | dispers- | |
| | binder for | presence | de- | ibility of | cyclic |
| | porous | of | formation | inorganic | charac- |
| | membrane | wrinkles | rate | particles | teristic |
| Example 1 | polymer “A” | A | A | A | A |
| Example 2 | polymer “B” | A | A | A | B |
| Example 3 | polymer “C” | A | A | A | B |
| Example 4 | polymer “D” | A | A | B | C |
| Comparative | PBA | A | A | C | F |
| Example 1 | | | | | |
| Comparative | PEO | A | B | E | G |
| Example 2 | | | | | |
| Comparative | PVDF | B | D | C | B |
| Example 3 | | | | | |
| Comparative | PAN | C | D | C | B |
| Example 4 | | | | | |

As seen from table 1, when binder forming the porous film is a copolymer comprising (meth)acrylonitrile monomer unit and (meth)acrylic ester monomer unit, dispersibility of inorganic particles in slurry for porous film is superior and it is capable to prevent deformation when coating on organic separator (Namely, film smoothness property is superior.), therefore, lithium ion secondary battery thereof has a long term cycle characteristic. Above all examples, Example 1, wherein copolymer forming the binder has mass ratio of (meth)acrylonitrile monomer unit and (meth)acrylic ester monomer unit within a range of 10/90 to 20/80 and include thermal crosslinking group and hydrophilic group, provide the best separator deformation property (namely, film smoothness property), inorganic particle dispersibility, and long term cycle characteristic.

1. A separator for lithium ion secondary battery characterized in that;
porous film including nonconductive particles and binder is laminated on organic separator,
and said binder includes copolymer comprising (meth)acrylonitrile monomer unit and (meth)acrylic ester monomer unit.

2. The separator for lithium ion secondary battery as set forth in claim 1 wherein;
ratio of (meth)acrylonitrile monomer unit and (meth)acrylic ester monomer unit (=(meth)acrylonitrile monomer unit/(meth)acrylic ester monomer unit) in the copolymer of the binder is within the range of 5/95 to 50/50 by mass ratio.

3. The separator for lithium ion secondary battery as set forth in claim 1 or 2 wherein;
total content of (meth)acrylonitrile monomer unit and (meth)acrylic ester monomer unit in the copolymer of the binder is 50 mass % or more.

4. The separator for lithium ion secondary battery as set forth in claim 1 wherein;
said binder is crosslinkable by heat or energy irradiation.

5. The separator for lithium ion secondary battery as set forth in claim 1 wherein;
said copolymer of the binder includes thermal crosslinkable group and said thermal crosslinkable group is at least one selected from the group consisting of epoxy group, N-methylol amide group and oxazoline group.

6. The separator for lithium ion secondary battery as set forth in claim 1 wherein;
said copolymer of the binder further includes at least one kind of hydrophilic group selected from the group consisting of carboxylic acid group, hydroxy group and sulfonic acid group.

7. A manufacturing method of a separator for lithium ion secondary battery characterized by comprising;
coating a slurry for porous film comprising nonconductive particles, binder including copolymer comprising (meth)acrylonitrile monomer unit and (meth)acrylic ester monomer unit, and solvent on organic separator, and drying the same.

8. A lithium ion secondary battery comprising;
a positive electrode, a negative electrode, an electrolyte solution, and the separator as set forth in claim 1.
